(19) United States
(12) Patent Application Publication
(10) Pub. No.: US 2019/0295202 A1
(43) Pub. Date: Sep. 26, 2019

(54) BLOCKCHAIN RECORDS ASSOCIATED WITH SEARCH WARRANT

(71) Applicant: CA, Inc., New York, NY (US)

(72) Inventors: Serge Mankovskii, Morgan Hill, CA (US); Steven L. Greenspan, Scotch Plains, NJ (US); Maria C. Velez-Rojas, Santa Clara, CA (US); Guy A. Di Lella, San Francisco, CA (US); Howard A. Abrams, San Mateo, CA (US); Navid Nader-Rezvani, Los Altos, CA (US); Mark Jacob Addleman, Oakland, CA (US); Otto Gabriel Berkes, Bedford Hills, NY (US); Paul Louis Pronsati, JR., Golden, CO (US)

(21) Appl. No.: 15/934,601

(22) Filed: Mar. 23, 2018

(51) Int. Cl. G06Q 50/26; H04L 9/32; H04L 29/06

(52) U.S. Cl. CPC G06Q 50/26; H04L 9/3247; H04L 63/308; H04L 2209/38; H04L 63/102; G06Q 2220/00; H04L 9/3271

(57) ABSTRACT

Techniques are disclosed relating to serving an electronic search warrant. In some embodiments, a computer system accesses a blockchain including an electronic warrant that authorizes access to a controlled device having confidential data. The computer system sends a request for the confidential data to the controlled device, the request identifying the electronic warrant. The computer system receives the confidential data from the controlled device and appends a first record to a second record in blockchain. The first record includes the confidential data, a first digital signature generated from the contents of the first record, and a second digital signature obtained from the second record. In some embodiments, the computer system sends a request for the electronic warrant to a second computer system associated with a court. The request identifies a public key for inclusion in the electronic warrant and having a private key to generate the first digital signature.

### BACKGROUND

### Technical Field

This disclosure relates generally to computer systems, and, more specifically, to storing data using blockchains.

### Description of the Related Art

People typically maintain large amounts of confidential information in their computing devices. For example, a person's mobile phone might contain contact information for friends and relatives as well as correspondence in the form of texts and email messages. A mobile device might also include personal photographs taken via the device's camera. It could also include financial information such as credit card numbers, transaction records, etc. To protect this information, modern computing devices may require authentication such as passcode, a user name and password, or some other form of user credential. Information maintained on a person's mobile device, however, may be pertinent to an ongoing investigation being performed by law enforcement. If a device owner is being uncooperative, law enforcement may seek the assistance of a court to obtain a search warrant to get access to the device—assuming such access can even be obtained.

### SUMMARY

The present disclosure describes embodiments in which a blockchain may be used to store information collected in conjunction with a search warrant. In some embodiments, a first computer system accesses a blockchain including an electronic warrant authorizing access to a controlled device having confidential data. The first computer system sends a request for the confidential data to the controlled device, where the request identifies the electronic warrant. The first computer system receives the confidential data from the controlled device and appends the confidential data in one or more records to the blockchain. In some embodiments, the first computer system sends a request for the electronic warrant to a second computer system associated with a court authorized to issue the electronic warrant, the request identifying a public key of the first computer system for inclusion in the electronic warrant. The first computer system then stores, in the blockchain, a record identifying the request for the electronic warrant. In such an embodiment, appending records of confidential data includes using a private key corresponding to the public key to generate digital signatures included in the records.

### BRIEF DESCRIPTION OF THE DRAWINGS

FIG. 1 is a block diagram illustrating one embodiment of a system using a blockchain to facilitate access to confidential information obtained through a warrant.

FIG. 2 is a block diagram illustrating one embodiment of a court computer system configured to insert records into the blockchain.

FIG. 3 is a block diagram illustrating one embodiment of a law enforcement computer system configured to insert records into the blockchain.

FIG. 4 is a block diagram illustrating one embodiment of a controlled device configured to access records in the blockchain.

FIGS. 5A-5C are flow diagrams illustrating embodiments of methods that use a blockchain.

FIG. 6 is a block diagram illustrating one embodiment of an exemplary computer system.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “temperature circuit configured to measure an internal operating temperature of a processing element” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus, the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, in a blockchain having a first record and a second record, the terms “first” and “second” can be used to refer to any two records of blockchain. In other words, the “first” and “second” records are not limited to the initial two records in the blockchain, for example.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

### DETAILED DESCRIPTION

Ensuring that law enforcement properly complies with an issued search warrant is important for preserving the integrity of the information collected via the search warrant. For example, a malicious actor might attempt to insert information collected after a search warrant has expired, alter information after it has been collected, and/or insert information collected from a source that was not authorized by the warrant. If any of these actions occur, it may potentially jeopardize valuable information about a case. Also, if a warrant has been issued to give law enforcement access to some computing device, it is important that the content of the device remain unmodified until it can be extracted by law enforcement.

The present disclosure describes embodiments of a system that allows law enforcement to obtain access to confidential information in a computing device while also ensuring proper enforcement of any issued search warrant. As will be describe below in various embodiments, computer systems can maintain a blockchain that includes records for various events associated with the creation and serving of a search warrant. For example, in some embodiments, the blockchain includes records associated with a request from law enforcement for a search warrant and the issuance of the search warrant by a court. Records can also be appended for information collected from a user's computing device responsive to the serving of the warrant. Being a blockchain, the records are made immutable by including the signatures (or hashes in other embodiments) of earlier records in later records, which are also signed. In some embodiments, the blockchain is also distributed among multiple computer systems such as a court computer system, law enforcement computer system, etc. to provide redundancy.

In various embodiments discussed below, a computing device for which a warrant is issued may be configured to permit access to confidential information stored in the device. In such an embodiment, the device may receive a copy of the search warrant (e.g., from the blockchain directly or from law enforcement) and grant access to the information in a manner in accordance with the search warrant. For example, the device may examine the warrant and not allow access to the device once the warrant has expired. The device may also prevent the confidential information from being modified while the warrant is still valid. In many instances, preserving information in this manner may allow for greater confidence in the integrity of the information collected resultant from a search warrant.

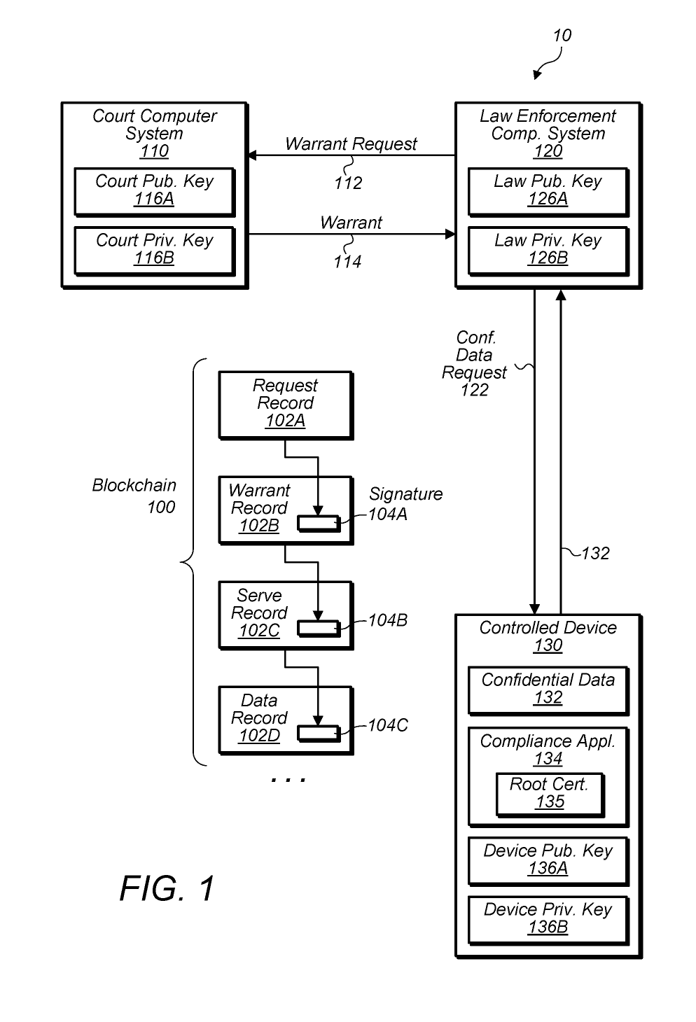

Turning now to FIG. 1, a block diagram of a system 10 using a block chain is depicted. In the illustrated embodiment, system 10 includes a blockchain 100 of records 102, a court computer system 110, law enforcement computer system 120, and a controlled device 130. As shown, systems 110, 120, and 130 includes public and private keys 116, 126, and 136, respectively. Controlled device 130 includes confidential data 132 and a compliance application 134 with a root certificate 135. In some embodiments, system 10 may be implemented differently than shown. For example, in some embodiments, additional computer systems may maintain a copy of blockchain 100. In some embodiments, one or more of systems 110 and 120 may be implemented by a virtual machine executing in a cloud computing environment.

As will be described in greater detail in various embodiments, blockchain 100 is operable to store various records 102 pertaining to the serving of an electronic search warrant 114 and the collection of information in association with the search warrant. Being a blockchain, blockchain 100 includes multiple records 102 linked together using digital signatures 104 (or hashes in other embodiments) generated from earlier records 102 in order to make the content of earlier records 102 immutable. For example, as shown, a digital signature 104A may be generated from the contents of record 102A and included in record 102A. That signature 104A may then be propagated record 102B, which is then signed to create digital signature 104B. Record 102C then includes digital signature 104B generated from the contents of record 102B. If a malicious actor attempted to modify the content in record 102A, a subsequently determined signature from record 102A's contents would no longer match signature 104A included in record 102B, indicating that the content of record 102A had been modified. If signature 104A in record 102B were to be replaced, however, a subsequently determined signature from record 102B would not match signature 104B in record 102C. Thus, integrity of records 102 is maintained through the chaining via signatures 104. Signatures 104 may be generated using any suitable algorithm such as the digital signature algorithm (DSA). In other embodiments, keyed-hash algorithms may be used such as hash message authentication code (HMAC). To further improve data integrity, blockchain 100 may be distributed among multiple computer systems. For example, in some embodiments, court computer system 110 and law enforcement computer system 120 maintain copies of blockchain 100. As part of maintaining blockchain 100, computer systems 110 and 120 may be responsible for verifying records 102 (and more particularly signatures 104) before permitting them to be appended to their respective copies. Although various examples of records 102 will be discussed below, more (or less) records 102 may be included in blockchain 100—e.g., blockchain 100 may include records 102 unrelated to the serving a warrant, records 102 associated with multiple cases, etc.

Court computer system 110, in one embodiment, is a computer system, which may be operated by a court to issue electronic search warrants. Accordingly, in the illustrated embodiment, court computer system 110 is configured to receive warrant request 112 from a law enforcement computer system 120. In various embodiments, this request 112 may specify various parameters of the warrant 114 such as the person associated with the search, what devices are being accessed, when the warrant should be valid, who is performing the search, etc. In response to receiving this request 112, court computer system 110 may provide a user interface, which may present the content of request 112 to a judge for review and allow the judge to authorize issuance of an electronic warrant 114 to law enforcement computer system 120.

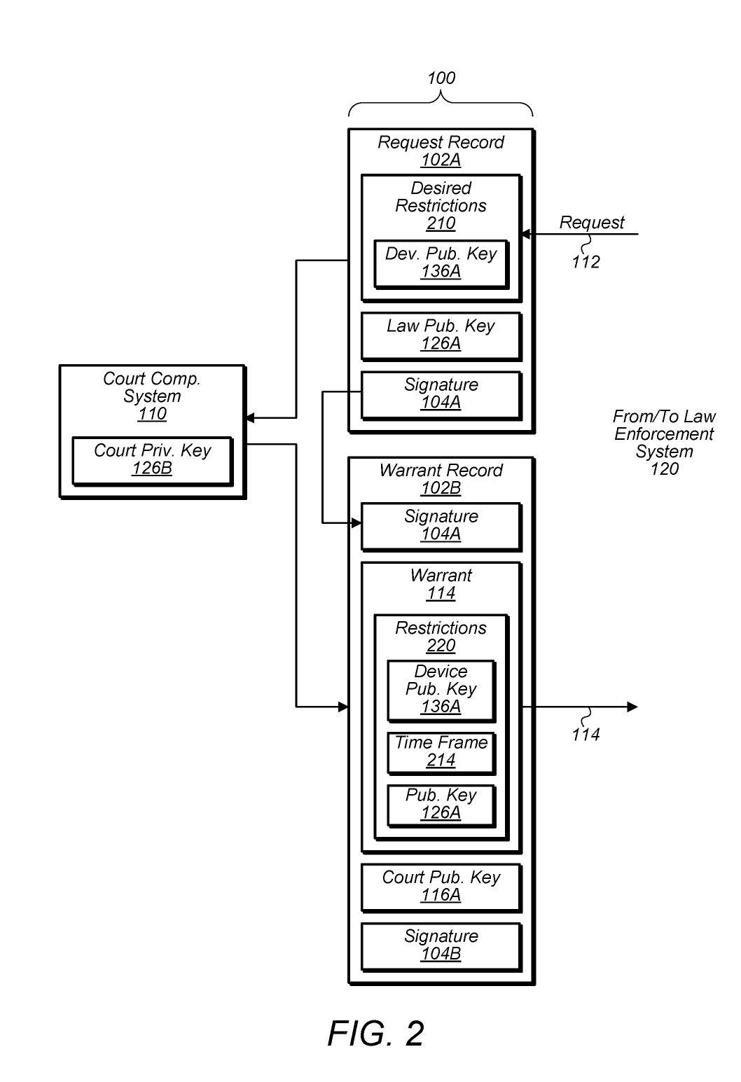

As warrant request 112 and warrant 114 are exchanged, in various embodiments, one or more corresponding request records 102A and warrant records 102B are inserted in blockchain 100. In some embodiments, these records 102 are signed by the private keys 116B and 126B of the computer systems 110 and 120 adding the records 102. Accordingly, in response to issuing a warrant request 112, law enforcement computer system 120 may add request record 102A to blockchain 100 and use law private key 126B to generate signature 104A attesting to the authenticity of request record 102A. Court computer system 110 may then verify record 102A by using law public key 126A to verify signature 104A against the content in record 102A before system 110 appends record 102A to its copy of blockchain 100. Similarly, in response to issuing a warrant 114, court computer system 110 may add a warrant record 102B including signature 104A and use court private key 116B to generate signature 104B. Law enforcement computer system 120 may then verify warrant record 102B by using court public key 116A to verify signature 104B prior to inserting warrant record 102B into its copy of blockchain 100. In some embodiments, keys 116, 126, 136 are certified by a trusted certificate authority (CA), which provides corresponding certificates for public key 116A, 126A, and 136A such as X.509 certificates. Examples of various content that may be include in request record 102A and warrant record 102B are discussed in greater detail below with respect to FIG. 2.

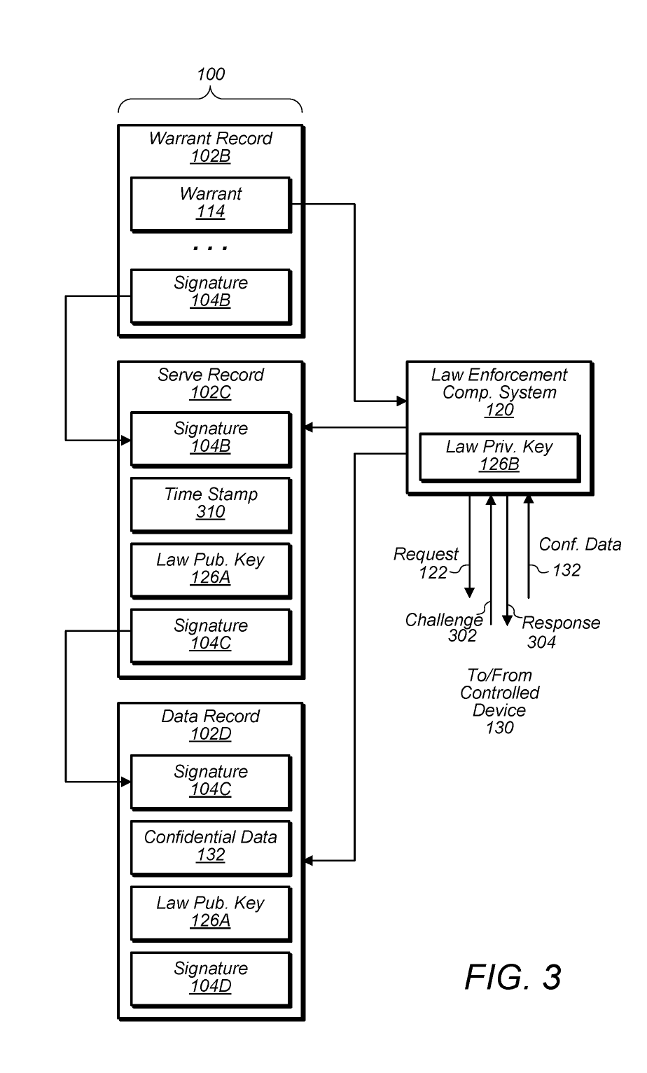

Law enforcement computer system 120, in one embodiment, is a computer system, which may be operated by law enforcement to request warrants and/or serve warrants to controlled devices 130 having confidential data 132. Accordingly, computer system 120 may provide a user interface that allows a law enforcement officer to specify various parameters for a search warrant and issue a corresponding warrant request 112 to court computer system 110 for review by a judge. In the illustrated embodiment, computer system 120 is also configured to serve warrant 114 in a request 122 for confidential data 132 from controlled device 130, and to record the obtained confidential data 132 in block chain 100. In some embodiments, computer system 120 is further configured to insert a serve record 102C in response to serving warrant 114 and/or one or more data records 102D for collected confidential data 132. As with records 102A and 102B, records 102C and 102D appended to blockchain 100 may be signed using law private key 126B and verifiable using law public key 126A. Examples of various content that may be include in records 102C and record 102D are discussed in greater detail below with respect to FIG. 3.

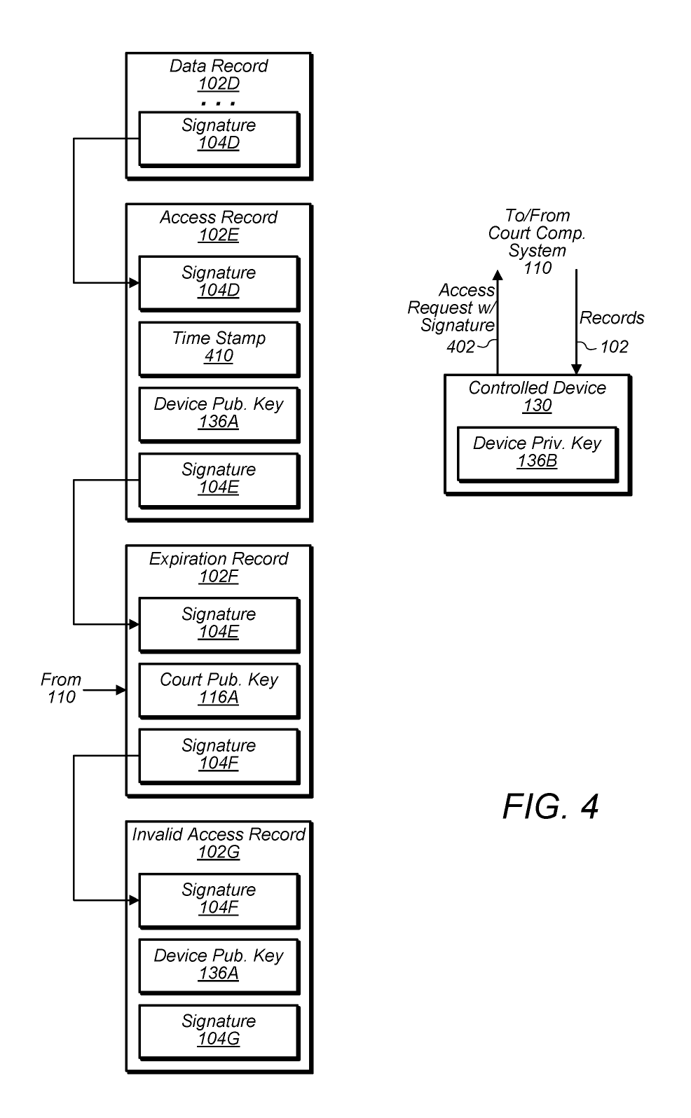

Controlled device 130, in one embodiment, is a computing device having confidential data 132, which may be obtained via a warrant 114. Accordingly, controlled device 130 may receive a request 122 for confidential data 132 corresponding to warrant 114 from law enforcement computer system 120 and may provide confidential data 132 responsive to request 122. In some embodiments, warrant 114 may be included in request 122. In other embodiments, controlled device 130 may obtain warrant 114 from blockchain 100 directly—e.g., by issuing a request to court computer system 110 for the warrant 114 in record 102B. In response to receiving warrant 114, device 130 may verify warrant 114 before permitting access to confidential data 132. In some embodiments, verification and enforcement of warrant 114 is performed by a compliance application 134 executing on device 130. In the illustrated embodiment, compliance application 134 verifies warrant 114 using a root certificate 135, which may a certificate (e.g., an X.509 certificate) for a certificate authority (CA) that certifies keys 116 and 126. Accordingly, warrant 114 may include a certificate issued for keys 116, which includes a signature verifiable using a public key in root certificate 135. In some embodiments, this certificate 135 is added to device 130 by device's 130 manufacturer, which may implement the CA. In some embodiments, application 134 may further authenticate law enforcement computer system 120 by asking it to perform a zero knowledge proof—e.g., a challenge-response exchange using keys 126 as will be discussed with respect to FIG. 3. In various embodiments, application 134 may also facilitate enforcement of warrant 114 such as preventing modification of confidential data 132 once warrant 114 has been served, permitting access to confidential data 132 only within the duration that warrant 114 is valid, etc. In some embodiments, controlled device 130 may also enable a user of device 130 to access portions of blockchain 100, which may result in a corresponding access record being appended to blockchain 100. An example of an access record and an expiration record which may be appended to block chain 100 are discussed in greater detail below with respect to FIG. 4.

Turning now to FIG. 2, a block diagram of court computer system 110's interaction with blockchain 100 is depicted. In the illustrated embodiment, court computer system 110 reads a request record 102A from blockchain 100 and writes a warrant record 102B to blockchain 100. In some embodiments, more (or less) records 102 may be used by court system 110. Records 102 may also be implemented in a different manner than shown.

As discussed above, law enforcement computer system 120 may issue a request 112 for a warrant 114 and insert a corresponding request record 102A into blockchain 100, which may be accessed by court computer system 110. In some embodiments, request 112 may be obtained via record 102A (or conveyed separately to system 110 in other embodiments). In the illustrated embodiment, this record 102A includes a set of desired restrictions for the warrant 114, law public key 126A, digital signature 104A. Desired restrictions 210 may include various criteria such as the person associated with the warrant 114, what devices are being searched, how long the warrant 114 should be valid, etc. In the illustrated embodiment, restrictions 210 further include the public key 136A of device 130, which may be used to permit device 130 to access portions of blockchain 100 as will be discussed below with FIG. 4. In some embodiments, law public key 126A is included in order to facilitate verification of signature 104A. In some embodiments, key 126A is included, so that it can also be included in warrant 114 for authenticating law enforcement computer system 120 as will be discussed with FIG. 3.

As discussed above, court computer system 110 may issue a corresponding warrant 114 and insert a corresponding warrant record 102B in blockchain 100. In the illustrated embodiment, warrant record 102B includes signature 104A from request record 102A, warrant 114, court public key 116A, and signature 104B. As noted above, signature 104A is included to chain record 102B to record 102A in order to make record 102A immutable. As shown, warrant 114 may include restrictions 220, which may correspond to desired restrictions 210. In some embodiments, restrictions 220 may include additional or different restrictions as determined by a judge. For example, restrictions 220 may specify certain actions that must take place prior to access, such as attempted notification of the owner of device 130 and/or owner's attorney. In such an embodiment, warrant 114 may function as a smart contract. In the illustrated embodiment, restrictions 220 include device public key 136A, time frame 214, and law public key 126A. Device public key 136A may be used to by controlled device 130 to confirm that it is the one for which the warrant 114 was issued. Time frame 214 may specify the time frame that warrant 114 is valid and may be used by device 130 to determine how long to enforce warrant 114. Again, public key 126A may be included to facilitate device 130's authentication of law enforcement computer system 120. In some embodiments, warrant 114 may also include a signature generated by court private key 126B; however, in the illustrated embodiment, signature 104B may be used to verify warrant 114. In various embodiment, court public key 116A is included to verify signature 104B generated by court private key 126B from warrant record 102B's contents.

Turning now to FIG. 3, a block diagram of law enforcement computer system 120's interaction with blockchain 100 is depicted. In the illustrated embodiment, computer system 120 writes a serve record 102C and a data record 102D to blockchain 100. In some embodiments, more (or less) records 102 may be used by computer system 120. Records 102 may also be implemented in a different manner than shown.

As discussed above, law enforcement computer system 120 may receive a warrant 114 and serve it to controlled device 130 to obtain confidential data 132. In some embodiments, system 120 may receive warrant 114 via record 102B (or receive warrant 114 separately in other embodiments). Upon serving it to controlled device 130, device 130 may verify warrant 114 and authenticate law enforcement computer system 120 via a challenge-response scheme. Accordingly, as shown, controlled device 130 may issue a challenge 302 having some data (e.g., random data) to be signed by law private key 126B. In response to receiving challenge 302, system 120 may sign the data and return the signature via response 304. In some embodiments, controlled device 130 verifies the signature in the response 304 using the law public key 126A included in warrant 114 in order to confirm system 120 is authorized by the warrant to access confidential information 132. In some embodiments, this scheme may further include verifying that restrictions 220 have been satisfied such as verifying the owner's attorney has been notified about the access attempt, the warrant 114 is still valid, etc.

In some embodiments, controlled device 130 may further implement joint monitoring when confidential data 132 is requested. In such an embodiment, access to data 132 may only be granted when the owner or owner's attorney is monitoring the exchange. In some embodiments, joint monitoring may also be performed if law enforcement is attempting to access device 130 in order to determine what content should be extracted.

After successfully verifying warrant 114 and authenticating system 120, controlled device 130 may permit system 120 to access confidential information 132. In some embodiments, confidential data 132 may be provided in a manner accessible to law enforcement computer system 120. In other embodiments, controlled device 130 may convey confidential data 132 in an encrypted manner without initially providing the corresponding decryption key. Doing so may, for example, allow law enforcement to take possession of data 132 if there is good reason to believe that the data might be deleted or modified, but would not allow them to read the data unless there was additional justification. The key might then be conveyed later by device 130 with approval from the owner, the owner's attorney, and/or a judge.

In response to serving warrant 114 to controlled device 130, law enforcement computer system 120 may insert a corresponding serve record 102C. As shown, this record 102C may include digital signature 104B from record 102B, a time stamp 310, law public key 126A, and a digital signature 104C. In various embodiments, signature 104B is included to chain record 102C to record 102B to preserve records 102B's contents. Time stamp 310 may be included to indicate when warrant 114 (along with additional information about the serving, which may be included in some embodiments). Law public key 126A may be included to identify law enforcement computer system 120 as the source of record 102C and to verify signature 104C.

After obtaining confidential data 132 from controlled device 130, law enforcement computer system 120 may insert one or more data records 102D. As shown, record 102D may include a digital signature 104C from the earlier record 102C, confidential data 132, law public key 126A, and a digital signature 104D. Again, signature 104C may be included to preserve the integrity of record 102C. Although confidential data 132 is shown as being included in a data record 102D, additional information related to the case may also be appended in a data record 102D. For example, if officers serving a warrant 114 are wearing body cameras, video collected by the cameras may be appended to blockchain 100 in records 102D. As with other records 102, law public key 126A may be included to identify system 120 as the source of record 102D and to verify signature 104D.

Turning now to FIG. 4, a block diagram of controlled device 130's interaction with blockchain 100 is depicted. In the illustrated embodiment, controlled device 130 reads content from blockchain 100 resulting in generation of an access record 102E. An expiration record 102F is also appended to blockchain 100 by court computer system 110. In some embodiments, more (or less) records 102 may be used. Records 102 may also be implemented in a different manner than shown.

As discussed above with respect to FIG. 2, controlled device 130's public key 136A may be recorded in blockchain 100 (e.g., in record 102A or in warrant 114 in record 102B) for various purposes. For example, in the illustrated embodiment, the recordation of key 136A is used to permit controlled device 130 to access one or more portions of blockchain 100. In particular, controlled device 130 may issue a request 402 to access one or more records 102 (e.g., record 102B having warrant 114) and include a digital signature generated with device private key 136B to attest to the identity of device 130. In response to receiving this request 402 and verifying the signature with the public key 136A in the blockchain, computer system 110 (or system 120) may grant access to one or more of the records 102. In some embodiments, other devices (e.g., a device belonging to the prosecution or defense) may be permitted to access blockchain 100 in a similar manner.

In some embodiments, a corresponding access record 102E is appended to blockchain 100 in response to blockchain 100 being accessed. As shown, this record 102E may include a signature 104D from record 102D, time stamp 410, device public key 136A, and signature 104E. In some embodiments, time stamp 410 indicates when the access occurred. Record 102E may also indicate what was accessed. In the illustrated embodiment, device public key 136A is included to identify device 130 as the source of record 102E and to verify signature 104E. In other embodiments, record 102E may come from a different source (e.g., computer system 110 or 120) and thus may include a different public key.

At some point, warrant 114 may expire after time frame 214 indicated in warrant 114 has passed (or a court may later determine that access should be denied or restricted). In various embodiments, court computer system 110 may append an expiration record 102F corresponding to this event. In some embodiments, this record 102F may serve to preserve the information recorded in blockchain 100 and collected in association with warrant 114. This record 102F may also serve to prevent additional information from being added to the blockchain after the warrant 114 has expired. Accordingly, if a malicious actor were to attempt to insert false evidence into the blockchain 100, this would result in a mismatch of signatures or a record being appended after record 102F, both indicating potential fraud. Thus, integrity of information in blockchain 100 is further maintained. As shown, record 102F includes signature 104E, court public key 116A, and signature 104F, which may be included for reasons similar to those discussed above for other records 102.

If someone, such as law enforcement computer system 120, attempts to access controlled device 130 in an unauthorized manner, controlled device 130 may append an invalid access record 102G. In the illustrated embodiment, record 102G includes signatures 104F, device public key 136A, and a signature 104G, which is generated using device private key 136B. In some embodiments, record 102G may include information about the attempted access such as a timestamp, IP address, an indication of why the attempted access was invalid, etc. Examples of invalid accesses may include attempting to access device 130 after a warrant 114 has expired, attempting to access device 130 in a manner not authorized by an unexpired warrant 114, failing to correctly authenticate with device 130 (e.g., not presenting a valid certificate), etc.

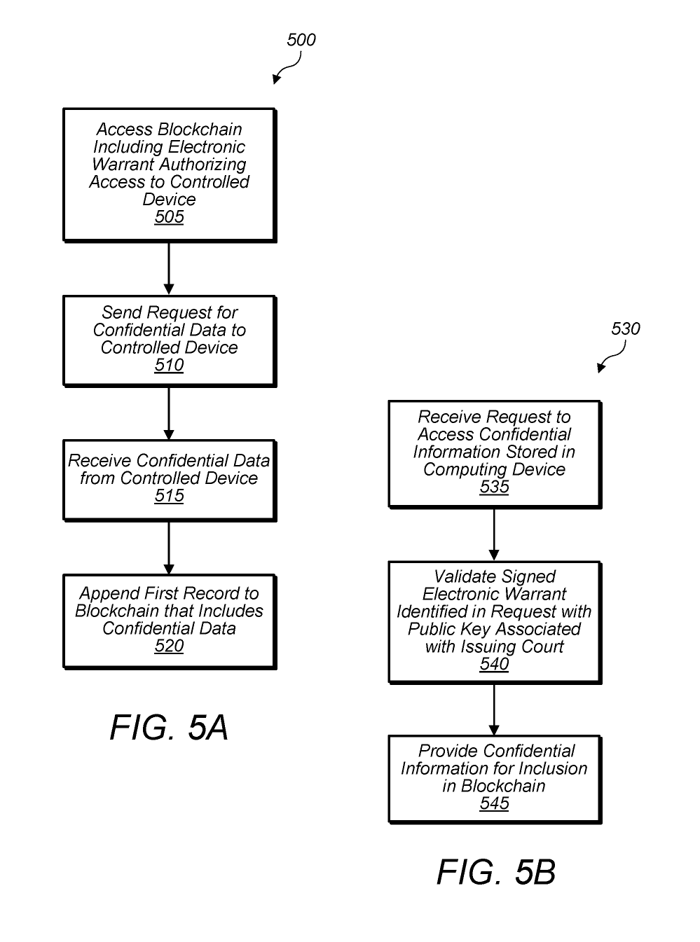

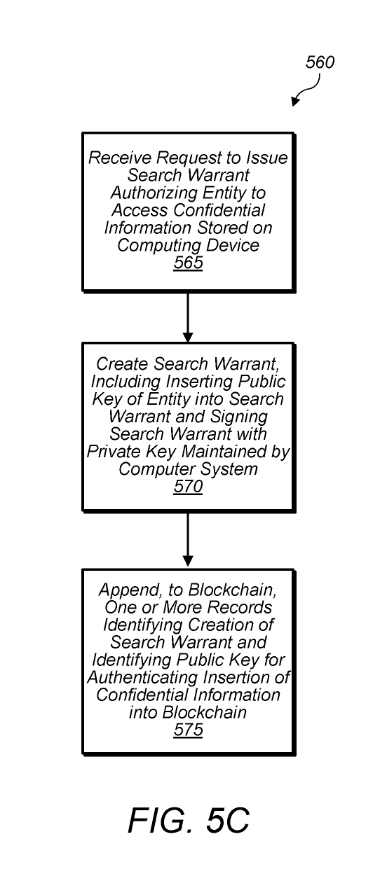

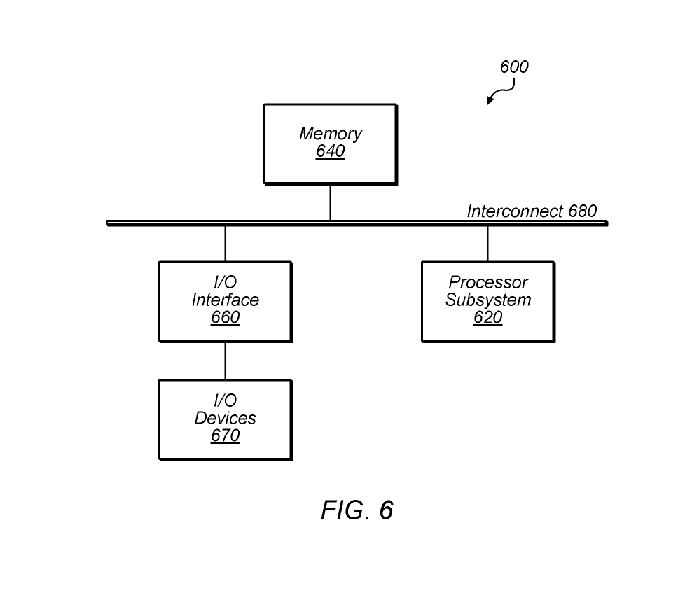

Turning now to FIG. 5A, a flow diagram of a method 500 is depicted. Method 500 is one embodiment of a method that may be performed by a first computer system associated with law enforcement such as computer system 120. In many instances, performance of method 500 may improve the integrity of information collected in accordance with a warrant by making the information immutable.

In step 505, a blockchain (e.g., blockchain 100) is accessed that includes an electronic warrant (e.g., warrant 114) authorizing access to a controlled device (e.g., device 130) having confidential data (e.g., data 132). In various embodiments, a request for the electronic warrant is sent to a second computer system associated with a court authorized to issue the electronic warrant. In some embodiments, the request identifies a public key (e.g., law enforcement public key 126A) of the first computer system for inclusion in the electronic warrant, and method 500 includes storing, in the blockchain, a record (e.g., request record 102A) identifying the request for the electronic warrant. In some embodiments, the record identifying the request for the electronic warrant includes a public key (e.g., device public key 136A) of controlled device for authenticating the controlled device to access at least a portion of the blockchain.

In step 510, a request (e.g., request 122) for the confidential data is sent to the controlled device. In various embodiments, the request identifies the electronic warrant. In some embodiments, in response to sending the request for the confidential data, method 500 includes receiving, from the controlled device, a request to authenticate including a challenge (e.g., challenge) from the controlled device and providing, to the controlled device, a signed response (e.g., response 304) including a digital signature generated using a private key (e.g., law enforcement private key 126B).

In step 515, the confidential data is received from the controlled device.

In step 520, a first record (e.g., data record 102D) is appended to a second record (e.g., serve record 102C) in the blockchain. In various embodiments, the first record includes the confidential data, a first digital signature (e.g., signature 104D) generated from the contents of the first record, and a second digital signature (e.g., signature 104C) obtained from the second record. In some embodiments, the appending includes using a private key (e.g., private key 126B) corresponding to the public key to generate the first digital signature included in the first record. In some embodiments, another record (e.g., another record 102D) including additional information collected in association with the electronic warrant is appended to the blockchain, the additional information including information collected from a source other than the controlled device. In some embodiments, the additional information includes video collected by a camera used by law enforcement. In some embodiments, after the electronic warrant has expired, a third record (e.g., expiration record 102F) appended to the blockchain is received such that the third record prevents additional confidential information collected from the controlled device from being appended by the first computer system to the blockchain.

Turning now to FIG. 5B, a flow diagram of a method 530 is depicted. Method 530 is one embodiment of a method that may be performed by a computing device having confidential information such as controlled device 130. In many instances, performance of method 530 may improve the integrity of information collected in accordance with a warrant by making the information immutable.

In step 535, a request (e.g., request 122) to access confidential information stored in the computing device is received from a first computer system (e.g., law enforcement computer system 120). In various embodiments, the request identifies a signed electronic warrant (e.g., warrant 114) included in a blockchain (e.g., record 102B in blockchain 100) accessible to the computing device. In some embodiments, the signed electronic warrant is included in request. In some embodiments, a request (e.g., request 402) for the signed electronic warrant is sent to a second computer system (e.g., court computer system 110) that maintains the blockchain, and the signed electronic warrant is received from the second computer system. In some embodiments, the signed electronic warrant indicates that a user of the computing device is prohibited from modifying the confidential information, and the computing device enforces the signed electronic warrant by prevent the user from modifying the confidential information for a duration that the signed electronic warrant is valid.

In step 540, the signed electronic warrant is validated with a public key (e.g., court public key 116A) associated with the court that issued the signed electronic warrant. In various embodiments, the validating includes issuing a challenge (e.g., challenge 302) to a second computer system that sent the request and receiving, from the second computer system, a response (e.g., response 304) to the challenge, the response including a digital signature generated by a second private key (e.g., law enforcement private key 126B). The validating further includes validating the digital signature with a second public key (e.g., law enforcement public key 126A) included in the warrant. In some embodiments, prior to receiving the request, the computing device stores a first certificate (e.g., root certificate 135) including a public key of a trusted authority and uses the public key of the trusted authority to validate the signed electronic warrant. In some embodiments, the first certificate identifies the trusted authority as a certificate authority, and step 535 includes receiving a second certificate corresponding the public key associated with the court. The second certificate identifies the certificate authority, and step 540 includes using the first certificate to validate the second certificate.

In step 545, the confidential information is provided for inclusion in the blockchain in response to validating the signed electronic warrant. In some embodiments, the signed electronic warrant specifies a duration (e.g., time frame 214) that the signed electronic warrant is valid for obtaining confidential information from the computing device, and method 530 includes the computing device enforcing the signed electronic warrant by servicing requests for confidential information only during the specified duration. In some embodiments, method 530 includes the computing device sending, to a second computer system, a request (e.g., request 402) to access at least a portion of the blockchain. In response to sending the request to access the portion of the blockchain, the computing device receives, from the second computer system, a challenge associated with a public key (e.g., device public key 136A) identified in the blockchain, uses a private key (e.g., device private key 136B) corresponding to the public key to generate digital signature based on the challenge, and sending a response to the challenge, the response including the digital signature.

Turning now to FIG. 5C, a flow diagram of a method 560 is depicted. Method 560 is one embodiment of a method that may be performed by a computer system associated with a court such as court computer system 110. In many instances, performance of method 560 may improve the integrity of information collected in accordance with a warrant by making the information immutable.

Method 560 begins in step 565 with a request (e.g., request 112) being received to issue a search warrant authorizing an entity (e.g., law enforcement computer system 120) to access confidential information (e.g., confidential data 132) stored on a computing device. In step 570, the search warrant (e.g., warrant 114) is created such that a public key (e.g., law enforcement public key 126A) of the entity is inserted into the search warrant and the search warrant is signed with a private key (e.g., court private key 116B) maintained by the computer system. In step 575, one or more records (e.g., a record 102B) are appended to the block chain to identify creation of the search warrant and identifying the public key (e.g., public key 126A) for authenticating insertion of the confidential information into the blockchain. In some embodiments, method 560 includes determining a time period (e.g., time frame 214) during which the search warrant authorizes the entity access to the confidential information, and in response to the determined time period passing, appending, to the blockchain, a record (e.g., expiration record 102F) prohibiting insertion of confidential information collected from the computing device after the time period has passed. In some embodiments, method 560 includes receiving, from a user associated with the computing device, a request (e.g., request 402) to access content in the blockchain and authenticating the user by issuing a challenge to the request and using a public key (e.g., public key 136A) included in the blockchain to validate a response to the challenge. In such an embodiment, method 560 further includes providing the search warrant in response to authenticating the user.

Exemplary Computer System

Turning now to FIG. 6, a block diagram of an exemplary computer system 600, which may implement one or more of elements 110, 120, and 130, is depicted. Computer system 600 includes a processor subsystem 620 that is coupled to a system memory 640 and I/O interfaces(s) 660 via an interconnect 680 (e.g., a system bus). I/O interface(s) 660 is coupled to one or more I/O devices 670. Computer system 600 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 600 is shown in FIG. 6 for convenience, system 600 may also be implemented as two or more computer systems operating together.

Processor subsystem 620 may include one or more processors or processing units. In various embodiments of computer system 600, multiple instances of processor subsystem 620 may be coupled to interconnect 680. In various embodiments, processor subsystem 620 (or each processor unit within 620) may contain a cache or other form of on-board memory.

System memory 640 is usable store program instructions executable by processor subsystem 620 to cause system 600 perform various operations described herein. System memory 640 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 600 is not limited to primary storage such as memory 640. Rather, computer system 600 may also include other forms of storage such as cache memory in processor subsystem 620 and secondary storage on I/O Devices 670 (e.g., a hard drive, storage array, etc.). In some embodiments, these other forms of storage may also store program instructions executable by processor subsystem 620 to implement functionality described above such as program instructions to implement functionality of court computer system 110, program instructions to implement functionality of law enforcement computer system 120, program instructions for compliance application 134, etc.

I/O interfaces 660 may be any of various types of interfaces configured to couple to and communicate with other devices, according to various embodiments. In one embodiment, I/O interface 660 is a bridge chip (e.g., Southbridge) from a front-side to one or more back-side buses. I/O interfaces 660 may be coupled to one or more I/O devices 670 via one or more corresponding buses or other interfaces. Examples of I/O devices 670 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 600 is coupled to a network via a network interface device 670 (e.g., configured to communicate over WiFi, Bluetooth, Ethernet, etc.).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory computer readable medium having program instructions stored therein, wherein the program instructions are executable by a first computer system to perform operations comprising:
accessing a blockchain including an electronic warrant authorizing access to a controlled device having confidential data;
sending a request for the confidential data to the controlled device, wherein the request identifies the electronic warrant;
receiving the confidential data from the controlled device; and
appending a first record to a second record in the blockchain, wherein the first record includes the confidential data, a first digital signature generated from the contents of the first record, and a second digital signature obtained from the second record.

2. The computer readable medium of claim 1, wherein the operations further comprise:
sending a request for the electronic warrant to a second computer system associated with a court authorized to issue the electronic warrant, wherein the request identifies a public key of the first computer system for inclusion in the electronic warrant; and
storing, in the blockchain, a record identifying the request for the electronic warrant; and
wherein the appending includes using a private key corresponding to the public key to generate the first digital signature included in the first record.

3. The computer readable medium of claim 2, wherein the operations further comprise:
in response to sending the request for the confidential data:
receiving, from the controlled device, a request to authenticate including a challenge from the controlled device; and
providing, to the controlled device, a signed response including a digital signature generated using the private key.

4. The computer readable medium of claim 2, wherein the record identifying the request for the electronic warrant includes a public key of the controlled device for authenticating the controlled device to access at least a portion of the blockchain.

5. The computer readable medium of claim 1, wherein the operations further comprise:
after the electronic warrant has expired, receiving a third record appended to the blockchain, wherein the third record prevents additional confidential information collected from the controlled device from being appended by the first computer system to the blockchain.

6. The computer readable medium of claim 1, wherein the operations further comprise:
appending, to the blockchain, a third record including additional information collected in association with the electronic warrant, wherein the additional information includes information collected from a source other than the controlled device.

7. The computer readable medium of claim 6, wherein the additional information includes video collected by a camera used by law enforcement.

8. A computing device, comprising:
one or more processors; and
memory have program instructions stored therein that are executable by the one or more processors to cause the computing device to perform operations comprising:
receiving, from a first computer system, a request to access confidential information stored in the computing device, wherein the request identifies a signed electronic warrant included in a blockchain accessible to the computing device;
validating the signed electronic warrant with a public key associated with a court that issued the signed electronic warrant; and
in response to validating the signed electronic warrant, providing the confidential information for inclusion in the blockchain.

9. The computing device of claim 8, wherein the validating includes:
issuing a challenge to a second computer system that sent the request;
receiving, from the second computer system, a response to the challenge, wherein the response includes a digital signature generated by a second private key; and
validating the digital signature with a second public key included in the warrant.

10. The computing device of claim 8, wherein the operations further comprise:
sending a request for the signed electronic warrant to a second computer system that maintains the blockchain; and
receiving the signed electronic warrant from the second computer system.

11. The computing device of claim 8, wherein the signed electronic warrant is included in request.

12. The computing device of claim 8, wherein the signed electronic warrant indicates that a user of the computing device is prohibited from modifying the confidential information; and
wherein the operations further comprise:
enforcing the signed electronic warrant by prevent the user from modifying the confidential information for a duration that the signed electronic warrant is valid.

13. The computing device of claim 8, wherein the signed electronic warrant specifies a duration that the signed electronic warrant is valid for obtaining confidential information from the computing device; and
wherein the operations further comprise:
enforcing the signed electronic warrant by servicing requests for confidential information only during the specified duration.

14. The computing device of claim 8, wherein the operations further comprise:
sending, to a second computer system, a request to access at least a portion of the blockchain;
in response to sending the request to access the portion of the blockchain:
receiving, from the second computer system, a challenge associated with a public key identified in the blockchain;
using a private key corresponding to the public key to generate digital signature based on the challenge; and
sending a response to the challenge, wherein the response includes the digital signature.

15. The computing device of claim 8, wherein the operations further comprise:
prior to receiving the request, storing a first certificate including a public key of a trusted authority; and
using the public key of the trusted authority to validate the signed electronic warrant.

16. The computing device of claim 15, wherein the first certificate identifies the trusted authority as a certificate authority;
wherein the receiving includes receiving a second certificate corresponding the public key associated with the court, and wherein the second certificate identifies the certificate authority; and
wherein the validating includes using the first certificate to validate the second certificate.

17. A non-transitory computer readable medium having program instructions stored therein, wherein the program instructions are executable by a computer system to perform operations comprising:
receiving a request to issue a search warrant authorizing an entity to access confidential information stored on a computing device;
creating the search warrant, including:
inserting a public key of the entity into the search warrant; and
signing the search warrant with a private key maintained by the computer system; and
appending, to a blockchain, one or more records identifying creation of the search warrant and identifying the public key for authenticating insertion of the confidential information into the blockchain.

18. The computer readable medium of claim 17, wherein the operations further comprise:
determining a time period during which the search warrant authorizes the entity access to the confidential information; and
in response to the determined time period passing, appending, to the blockchain, a record prohibiting insertion of confidential information collected from the computing device after the time period has passed.

19. The computer readable medium of claim 17, wherein the operations further comprise:
receiving, from a user associated with the computing device, a request to access content in the blockchain; and
authenticating the user by:
issuing a challenge to the request; and
using a public key included in the blockchain to validate a response to the challenge.

20. The computer readable medium of claim 19, wherein the operations further comprise:
providing the search warrant in response to authenticating the user.
